(19) United States
(12) Patent Application Publication
(10) Pub. No.: US 2019/0394548 A1
(43) Pub. Date: Dec. 26, 2019

(54) SUPPORT STRUCTURE FOR AUDIO EXCITER

(71) Applicant: Otis Elevator Company, Farmington, CT (US)

(72) Inventor: Paul A. Stranieri, Bristol, CT (US)

(21) Appl. No.: 16/013,775

(22) Filed: Jun. 20, 2018

(51) Int. Cl. H04R 1/02; B66B 1/14; B66B 1/34

(52) U.S. Cl. CPC H04R 1/028; H04R 2400/03; B66B 1/34; B66B 1/14

(57) ABSTRACT

A mounting assembly includes a body including a generally planar support wall and at least one connector extending from the support wall, an opening formed in the support wall, and an audio exciter coupled to the body via the opening such that a portion of the audio exciter is oriented for contact with a vibrational surface.

### BACKGROUND

Embodiments disclosed herein relate to an exciter, and more particularly, to system for mounting an exciter within a user interface device, such as a hall call panel of an elevator system.

Elevator systems are provided with multiple user interfaces to enable passengers to access and use the elevator. For example, these interfaces may be used to call an elevator car to travel to different floors within a building. Such user interfaces typically communicate with a user via one or more of a visual and/or audio cue One type of user interface is a hall call panel, typically located proximate an elevator landing door in a hallway, lobby, or landing of an elevator system. A hall call panel may be configured to enable passengers to call an elevator car and/or to provide various types of information to potential passengers. For example, the hall call panel may indicate that an elevator has already been called, or in destination dispatching systems, may indicate to a user, which elevator within a bank of elevators will respond to the call.

### BRIEF DESCRIPTION

According to an embodiment, a mounting assembly includes a body including a generally planar support wall and at least one connector extending from the support wall, an opening formed in the support wall, and an audio exciter coupled to the body via the opening such that a portion of the audio exciter is oriented for contact with a vibrational surface.

In addition to one or more of the features described above, or as an alternative, in further embodiments the opening is sized to receive and retain the audio exciter via a friction fit.

In addition to one or more of the features described above, or as an alternative, in further embodiments the audio exciter applies a pressure to the vibrational surface in a plane oriented parallel to the support wall.

In addition to one or more of the features described above, or as an alternative, in further embodiments the audio exciter further comprises an exciter body and a flange extending outwardly from an end of the exciter body, the generally planar support wall being disposed in contact with the flange.

In addition to one or more of the features described above, or as an alternative, in further embodiments the at least one connector is affixable to another surface, distinct from the vibrational surface.

In addition to one or more of the features described above, or as an alternative, in further embodiments a height of the at least one connector is less than a height of the audio exciter.

In addition to one or more of the features described above, or as an alternative, in further embodiments comprising a mounting flange extending from a distal end of the at least one connector, the mounting flange being affixable to another surface, distinct from the vibrational surface.

In addition to one or more of the features described above, or as an alternative, in further embodiments the mounting flange has a length of up to 7 mm.

According to another embodiment, a user interface device includes a body, a mechanism for receiving a user input, an audio exciter, and a primary support for mounting the audio exciter at a desired position in contact with a vibration surface of the body. A secondary support for mounting the audio excited includes an opening within which a portion of the audio exciter is positioned. The secondary support retains the audio exciter at the desired position in contact with a vibration surface of the body. The secondary support is distinct from the primary support.

In addition to one or more of the features described above, or as an alternative, in further embodiments the secondary support provides redundancy in the event of a failure of the primary support.

In addition to one or more of the features described above, or as an alternative, in further embodiments the secondary support is coupled to the audio exciter via an interference fit.

In addition to one or more of the features described above, or as an alternative, in further embodiments the opening is equal to or slightly smaller than the audio exciter.

In addition to one or more of the features described above, or as an alternative, in further embodiments the primary support is an adhesive material disposed between the audio exciter and the surface.

In addition to one or more of the features described above, or as an alternative, in further embodiments the audio exciter further comprises an exciter body and a flange extending outwardly from an end of the exciter body, the secondary support being disposed in contact with and applying a pressure to the flange.

In addition to one or more of the features described above, or as an alternative, in further embodiments the secondary support further comprises a support wall oriented generally parallel to the flange, the opening for receiving the audio exciter being formed in the support wall.

In addition to one or more of the features described above, or as an alternative, in further embodiments the secondary support further comprises at least one connector extending from the support wall.

In addition to one or more of the features described above, or as an alternative, in further embodiments the at least one connector is affixable to another surface, distinct from the vibrational surface.

In addition to one or more of the features described above, or as an alternative, in further embodiments the secondary support further comprises a mounting flange extending from the at least one connector, the mounting flange being affixable to another surface, distinct from the vibrational surface.

In addition to one or more of the features described above, or as an alternative, in further embodiments the user interface device is a component of an elevator system.

In addition to one or more of the features described above, or as an alternative, in further embodiments the user interface device is a hall call panel.

In addition to one or more of the features described above, or as an alternative, in further embodiments the user interface device is a car operating panel.

### BRIEF DESCRIPTION OF THE DRAWINGS

The following descriptions should not be considered limiting in any way. With reference to the accompanying drawings, like elements are numbered alike:

FIG. 1 is a perspective view of an example of an elevator system;

FIG. 2 is a schematic diagram of a front view of an example of a user interface device;

FIG. 3 is a perspective view of a portion of a user interface device according to an embodiment;

FIG. 4 is a top perspective view of a secondary support of an audio exciter for use with a user interface device according to an embodiment;

FIG. 5 is a top perspective view of a secondary support and an audio exciter for use with a user interface device according to an embodiment; and

FIG. 6 is a side perspective view of a secondary support of an audio exciter for use with a user interface device according to an embodiment.

### DETAILED DESCRIPTION

A detailed description of one or more embodiments of the disclosed apparatus and method are presented herein by way of exemplification and not limitation with reference to the Figures.

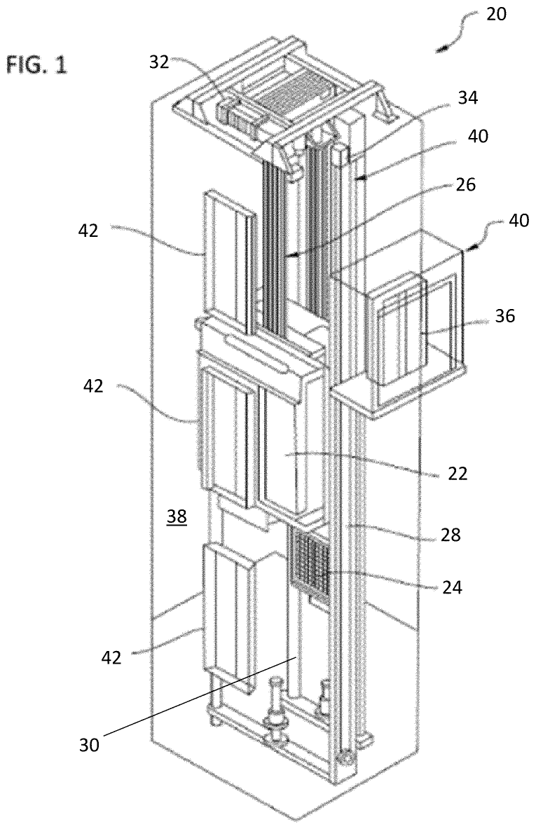

With reference to FIG. 1, a perspective view of an elevator system 20 is shown. The elevator system 20 includes an elevator car 22, a counterweight 24, one or more tension members 26, a guide rail 28, a machine 32, a position encoder 34, and an elevator controller 36. The elevator car 22 and the counterweight 24 are connected to each other by the at least one tension member 26. The tension members 26 may include or may be configured as, for example, ropes, steel cables, and/or coated-steel belts. The counterweight 24 is configured to balance a load of the elevator car 22 and facilitate movement of the elevator car 22 concurrently, and in an opposite direction, with respect to the counterweight 24 within an elevator hoistway 38. Movement of the elevator car 22 within the hoistway 36 is guided by the car guide rail 28. Similarly, movement of the counterweight 24 within the hoistway 38 be guided by one or more counterweight guide rails 30.

The tension members 26 are arranged in frictional contact with a machine 32. The machine 32 may include a motor or similar driving mechanism and is configured to control movement of the elevator car 22 and the counterweight 24. In an embodiment, the machine 32 is part of an overhead structure of the elevator system 20. The overhead structure may be located in a separate machine room, or alternatively, may be located adjacent an upper landing, within the hoistway 38.

In the illustrated, non-limiting embodiment, the elevator controller 36 is located in a controller room 40 within the hoistway 38 and is configured to control operation of the elevator system 20, and in particular, movement of the elevator car 22 between a plurality of landings 42. For example, the elevator controller 36 may provide drive signals to the machine 32 to control the acceleration, deceleration, leveling, stopping, etc. of the elevator car 22. The elevator controller 36 may also receive position signals form the position encoder 34. Although shown in a controller room 40, embodiments where the elevator controller 36 is located at another position relative to the elevator system 20 are also within the scope of the disclosure. Further, although shown and described with a roping system including one or more tension members 26, an elevator system 20 that employs another method and/or mechanism for moving the elevator car 22 within the hoistway 38 between the plurality of landings 42 is also contemplated herein.

An elevator system 20, such as system of FIG. 1, typically includes a plurality of user interface devices 50 that are operably coupled to the controller 36. The user interface devices 50 not only allow a user to call the elevator car 22, but also provide audio and/or visual communication with a user. Examples of such interface devices 50 include, but are not limited to, a car operating panel located within the interior of the elevator car 22, and a hall call panel, such as commonly located at a landing 42 of the elevator system 20.

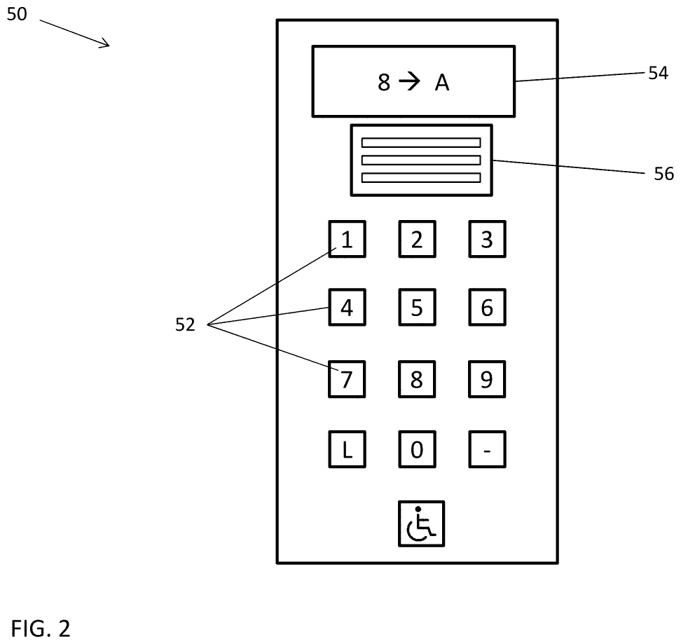

An example of a user interface device 50 is illustrated in more detail in FIG. 2. The user interface device 50 is configured to receive one or more inputs from a user. In an embodiment, the user interface device 50 includes one or more buttons 52 or other control input devices (not shown), such as for selecting a direction of travel or for entering a desired destination floor for example. Alternatively or in addition, the user interface device 50 may include a touch screen, or may be configured to receive an input from a smart device, such as a phone or tablet for example, via an “app” or other suitable connection.

In the illustrated, non-limiting embodiment, the user interface device 50 includes a visual display 54 configured to provide a user with information regarding the status of the elevator system. For example, the display 54 may indicate a current operational status of the elevator system 20, such as the position of the elevator car 22 within the hoistway 38. Alternatively, or in addition, the display 54 may indicate which elevator of a bank of elevators will answer the hall call entered by the user. In another embodiment, the user interface device 50 may include an audio mechanism 56, such as a speaker for example, configured to provide a user with audio information regarding the status of the elevator system 20. For example, the audio mechanism 56 may announce the current location of the elevator car 22, or may announce which elevator of a bank of elevators will answer the hall call entered by the user.

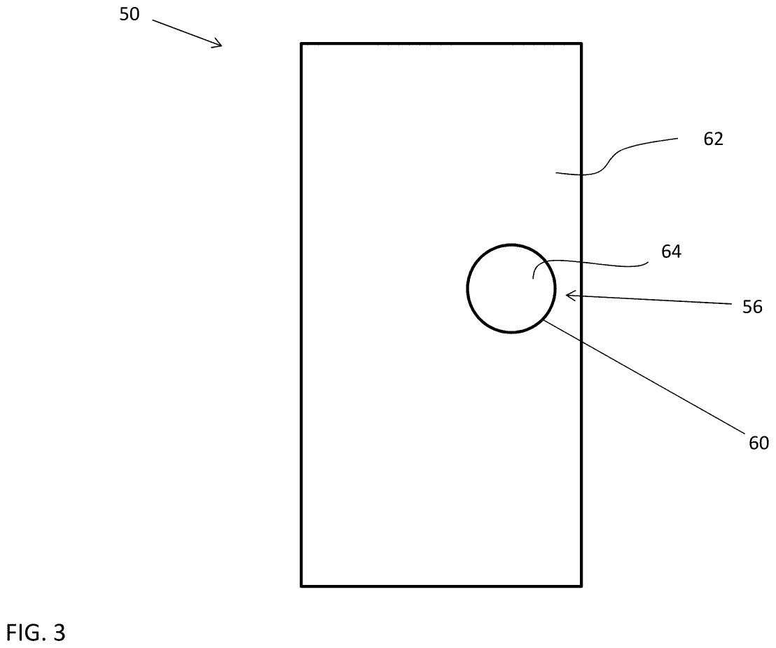

With reference now to FIG. 3, in an embodiment, the audio mechanism 56 of the user interface device 50 includes an audio exciter. In the illustrated non-limiting embodiment, the audio exciter 56 includes a body 60 and has a radially outwardly extending flange 61 disposed adjacent a first end of the body 60.

As best shown in FIG. 3, the audio exciter 56 is mounted to a surface 62 of the user interface device 50, such as the back surface of the user interface device 50, or the back surface of a front wall of the user interface device 50 for example, within the interior of the device 50. However, it should be understood that any suitable surface of the user interface device 50 is considered within the scope of the disclosure. When a signal is transmitted to the audio exciter 56, the exciter 56 vibrates at the frequency of the signal. Those vibrations are transferred through the surface 62 to which the exciter 56 is coupled, thus generating a desired sound. Accordingly, an exciter 56 may be used to output a sound from a user interface device 50 that does not have any speaker holes formed therein. However, it should be understood that embodiments where the user interface device 50 includes one or more speaker holes (not shown) are also within the scope of the disclosure.

In the illustrated, non-limiting embodiment, the surface 62 of the user interface device 50 is formed from a panel or sheet of a glass material. However, embodiments where the surface 62 is formed from another suitable material are also within the scope of the disclosure. A primary support 64 is used to retain the audio exciter 56 at a desired position relative to the surface 62 of the user interface device 50. In an embodiment, the primary support 64 includes an adhesive, such as glue for example, that is used to affix a portion of the audio exciter 56 to the glass surface 62. In an embodiment, the adhesive 64 is applied to the body 60 of the audio exciter 56, such as to a planar major surface thereof for example, and the major surface of the body 60, including the adhesive, is then disposed in contact with the surface 62 of the device 50.

The primary support or attachment 64 between the audio exciter 56 and the surface 62 of the user interface device 50 may be susceptible to various types of failure, causing the audio exciter 56 to separate from the surface 62. For example, the adhesion between the audio exciter 56 and the surface 62 may degrade due to fluctuations in temperature and/or humidity. Alternatively, or in addition, vibrations experienced by the user interface device 50 may cause the audio exciter 56 to separate from the surface 62. To prevent this separation, a secondary support 70 may be used to mount the audio exciter 56 within the user interface device 50. The secondary support 70 may provide redundancy such that in the event of a failure of the primary support 64, the audio exciter 56 remains in contact with the surface 62 of the user interface device 50 and, thus, continues to function properly.

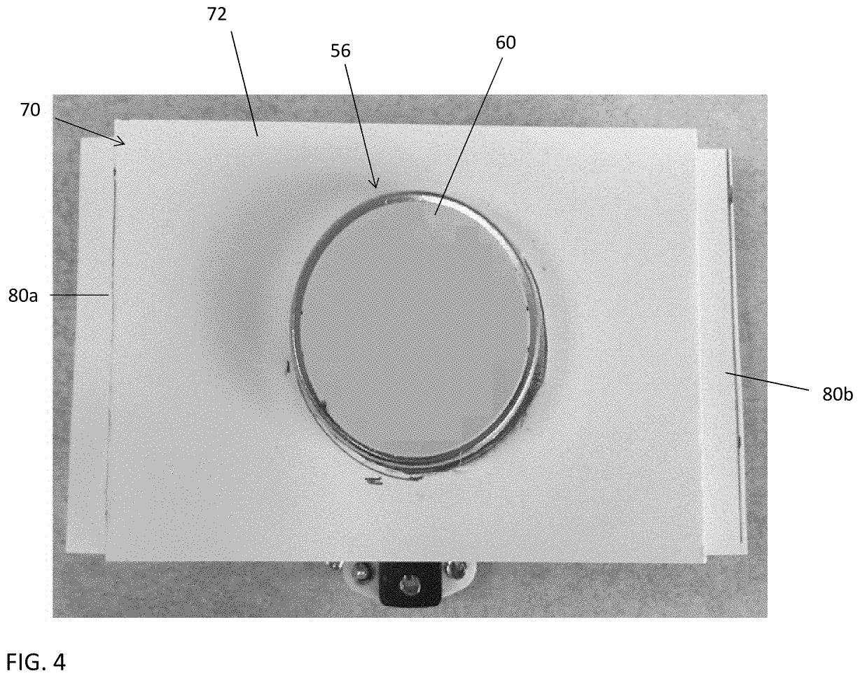

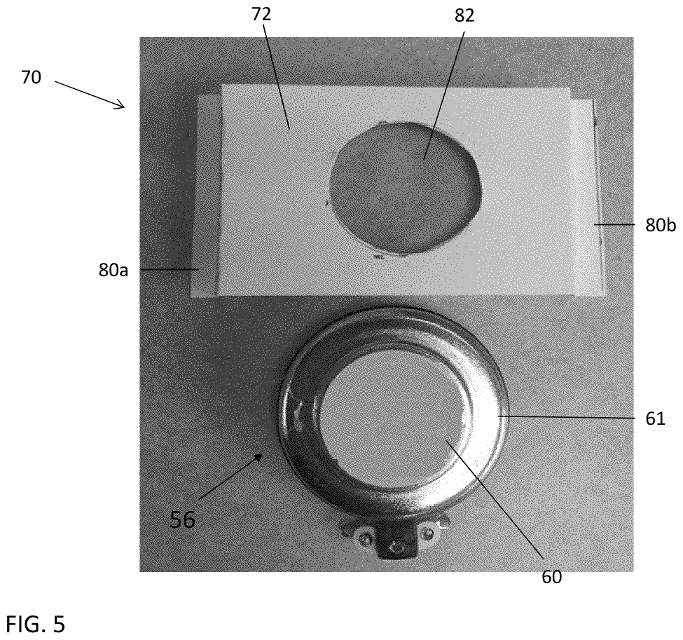

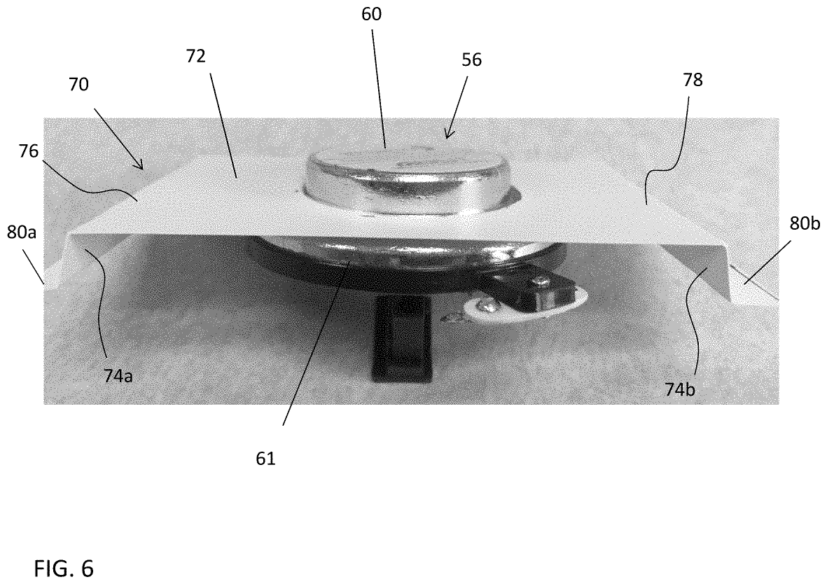

With reference to FIGS. 4-6, an example of the secondary support 70 is illustrated in more detail. As shown, the secondary support 70 includes a mounting bracket having a generally planar support wall 72 and at least one connector 74 extending from the support wall 72. The secondary support 70 may be formed from a lightweight, durable, and in some embodiments, flexible material, such as aplastic for example. However, other suitable materials are also within the scope of the disclosure. In the illustrated, non-limiting embodiment, best shown in FIG. 6, a first connector 74a extends from a first end 76 of the support wall 72 and a second connector 74b extends from a second, opposite end 78 of the support wall 72. Although a first and second connector 74a, 74b are illustrated, it should be understood that embodiments having only a single connector 74, or alternatively, embodiments having more than two connectors 74 are also within the scope of the disclosure. Further, in an embodiment, the height of each connector 74 is generally less than an overall height of the audio exciter 56.

The free end of at least one connector 74 is configured to couple the mounting bracket 70 to a surface of the user interface device 50. In an embodiment, the at least one connector 74 includes a mounting flange 80 extending at an angle to the connector 74. In an embodiment, the mounting flange 80 has a length of up to about 7 mm. The at least one connector 74, or alternatively, the mounting flange 80 may be operable to couple to a surface of the user interface device 50, separate from the surface 62 to which the audio exciter 56 is mounted. For example, the first connector 74a and the first mounting flange 80a extending therefrom may couple to a first side of the user interface device 50 arranged adjacent the surface 62, and the second connector 74b and the second mounting flange 80b extending therefrom may couple to a second side of the user interface device 50 located adjacent the surface 62. The mounting bracket 70 may couple to the user interface device 50 via any suitable connection mechanism, including, but not limited to an adhesive or one or more fasteners for example.

The support wall 72 has a length and width greater than the audio exciter 56. In an embodiment, an opening or through hole 82 is formed in the support wall 72. Although the opening 82 is illustrated as being located at a center of the support wall 72, embodiments where the opening 82 is offset from the center, such as near the first end 76 or a second opposite end 78 for example, are also within the scope of the disclosure. As best shown in FIG. 6, the opening 82 is sized to receive the body 60 of the audio exciter 56 such that the generally planar support wall 72 may be disposed in contact with a surface of the flange 61. In an embodiment, the overall dimensions of the opening 82 are substantially identical to or slightly smaller than the dimensions of the body 60 of the audio exciter 56 such that the body 60 of the audio exciter 56 is received within the opening 82 via a friction or interference fit. This friction fit restricts movement of the audio exciter 56 relative to the mounting bracket 70 while applying a minimal holding force to the audio exciter 56, thereby minimizing interference with the performance of the exciter 56. Further, this interference fit maintains the pressure between the audio exciter 56 and the vibrational surface 62, which is oriented generally parallel to the planar wall 72 of the mounting bracket 70. In an embodiment, the secondary support 70 may include a flexible portion, such as arranged adjacent a back surface of the audio exciter 56 for example. Together, the audio exciter 56 and the flexible portion may cooperate to function in a manner similar to a loud speaker.

Inclusion of the mounting bracket 70 allows the exciter 56 to remain in contact with the vibrating surface 62 of the user interface device 50, thereby ensuring continued functionality of the exciter 56 in the event that the adhesive 64 coupling the exciter 56 to the vibrating surface 62 of the user interface device 50 fails.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A mounting assembly comprising:
a body including a generally planar support wall and at least one connector extending from the support wall;
an opening formed in the support wall;
an audio exciter coupled to the body via the opening such that a portion of the audio exciter is oriented for contact with a vibrational surface.

2. The mounting assembly of claim 1, wherein the opening is sized to receive and retain the audio exciter via a friction fit.

3. The mounting assembly of claim 1, wherein the audio exciter applies a pressure to the vibrational surface in a plane oriented parallel to the support wall.

4. The mounting assembly of claim 1, wherein the audio exciter further comprises:
an exciter body; and
a flange extending outwardly from an end of the exciter body, the generally planar support wall being disposed in contact with the flange.

5. The mounting assembly of claim 1, wherein the at least one connector is affixable to another surface, distinct from the vibrational surface.

6. The mounting assembly of claim 1, wherein a height of the at least one connector is less than a height of the audio exciter.

7. The mounting assembly of claim 5, further comprising a mounting flange extending from a distal end of the at least one connector, the mounting flange being affixable to another surface, distinct from the vibrational surface.

8. The mounting assembly of claim 7, wherein the mounting flange has a length of up to 7 mm.

9. A user interface device comprising:
a body;
a mechanism for receiving a user input; and
an audio exciter,
a primary support for mounting the audio exciter at a desired position in contact with a vibration surface of the body; and
a secondary support including an opening within which a portion of the audio exciter is positioned, wherein the secondary support retains the audio exciter at the desired position in contact with a vibration surface of the body, the secondary support being distinct from the primary support.

10. The user interface device of claim 9, wherein the secondary support provides redundancy in the event of a failure of the primary support.

11. The user interface device of claim 9, wherein the secondary support is coupled to the audio exciter via an interference fit.

12. The user interface device of claim 11, wherein the opening is equal to or slightly smaller than the audio exciter.

13. The user interface device of claim 9, wherein the primary support is an adhesive material disposed between the audio exciter and the surface.

14. The user interface device of claim 9, wherein the audio exciter further comprises:
an exciter body; and
a flange extending outwardly from an end of the exciter body, the secondary support being disposed in contact with and applying a pressure to the flange.

15. The user interface device of claim 14, wherein the secondary support further comprises a support wall oriented generally parallel to the flange, the opening for receiving the audio exciter being formed in the support wall.

16. The user interface device of claim 14, wherein the secondary support further comprises at least one connector extending from the support wall.

17. The user interface device of claim 16, wherein the at least one connector is affixable to another surface, distinct from the vibrational surface.

18. The user interface device of claim 16, wherein the secondary support further comprises a mounting flange extending from the at least one connector, the mounting flange being affixable to another surface, distinct from the vibrational surface.

19. The user interface device of claim 9, wherein the user interface device is a component of an elevator system.

20. The user interface device of claim 19, wherein the user interface device is a hall call panel.

21. The user interface device of claim 19, wherein the user interface device is a car operating panel.
